(19) United States
(12) Patent Application Publication
(10) Pub. No.: US 2026/0119163 A1
(43) Pub. Date: Apr. 30, 2026

(54) INTELLIGENT VERSION RECOMMENDATION SYSTEM

(71) Applicant: SAP SE, Walldorf (DE)

(72) Inventors: Deepak Shiva, Bangalore (IN); Dilip Mamidela, Bangalore (IN)

(73) Assignee: SAP SE, Walldorf (DE)

(21) Appl. No.: 18/929,372

(22) Filed: Oct. 28, 2024

(51) Int. Cl. G06F 8/71; G06F 8/65

(52) U.S. Cl. CPC G06F 8/71; G06F 8/65

(57) ABSTRACT

A computer-implemented method can identify a current version of a dependent library used by a given software based on an input received from a user interface, obtain metadata of the dependent library comprising one or more change logs of the dependent library which include descriptions of a latest version of the dependent library, generate a prompt based on a prompt template which includes a placeholder for receiving selected metadata of the dependent library, prompt a generative artificial intelligence model using the prompt to determine whether updating the dependent library from the current version to the latest version can cause a failure mode of the given software, and present a response generated by the generative artificial intelligence model on the user interface. Related systems and software for implementing the method are also disclosed.

### BACKGROUND

Versioning in software applications, particularly in the free and open-source software (FOSS) environment, is crucial for maintaining compatibility, security, and functionality. However, the continuous evolution of FOSS components, with frequent updates and feature changes, poses significant challenges. Developers must manually review changelogs and release notes to identify breaking or incompatible changes, which is time-consuming and labor-intensive. Additionally, ensuring that updates do not introduce security vulnerabilities adds another layer of complexity. Thus, room for improvements exists for improving the efficiency and accuracy of version management in software development.

### BRIEF DESCRIPTION OF THE DRAWINGS

FIG. 1 is an overall block diagram of an example computing system supporting intelligent version recommendation for software applications.

FIG. 2 is a flowchart illustrating an example overall method for implementing intelligent version recommendation for software applications.

FIG. 3 is an architecture diagram of an example large language model.

FIG. 4 is a block diagram of an example computing system in which described embodiments can be implemented.

FIG. 5 is a block diagram of an example cloud computing environment that can be used in conjunction with the technologies described herein.

### DETAILED DESCRIPTION

### Overview of Software Version Management

Software version management is a critical aspect of software development and maintenance, ensuring that applications remain compatible, secure, and functional as they evolve. Effective version management allows developers to track changes, manage dependencies, and implement updates without disrupting the existing functionality. This process is important for maintaining the integrity of the software, preventing security vulnerabilities, and ensuring that new features and improvements can be integrated seamlessly.

However, managing software versions is inherently complex and technically challenging. Software often comprises numerous components involving hundreds or thousands of libraries, each of which can have many different versions. The continuous evolution of these components, especially in the FOSS environment, results in frequent updates and feature changes. Each new version of a component may introduce breaking changes, deprecate existing functionalities, or alter dependencies, requiring developers to meticulously review changelogs and release notes. This manual effort to identify and adapt to these changes is time-consuming and prone to errors, making the process labor-intensive and inefficient.

Existing solutions, such as Dependabot and Renovate, can automate the tracking and recommendation of the latest versions of libraries used in development projects. However, these tools fall short in addressing the critical issue of breaking changes. For example, these tools do not verify if the newer versions are incompatible with the existing codebase, leaving developers to manually validate and test each update. This gap in functionality means that developers still face significant challenges in ensuring that updates do not introduce new issues or vulnerabilities, often resulting in additional workload, potential delays, and increased risk of errors.

Moreover, the effort required to adapt code to work with breaking changes in newer versions can be substantial. Developers must not only understand the changes but also modify the codebase accordingly, which can take from a few hours to several days in many circumstances. This effort is compounded when multiple libraries are involved in the software application, each with its own set of changes and potential incompatibilities. The cumulative time and resources spent on managing these updates can significantly impact the overall productivity and efficiency of the development team.

The technologies described herein address the above challenges by implementing an intelligent version recommendation system which leverages the power of artificial intelligence (AI). As described more fully below, this new solution can intelligently analyze newer versions of software libraries and components to check for breaking or incompatible changes. By providing detailed information about these changes, the system enables developers to make informed decisions when upgrading versions, reducing the manual effort and time required for validation. The disclosed intelligent version recommendation system not only can enhance the efficiency and accuracy of version management but also can help maintain the stability and security of the software.

### Example Computing System for Intelligent Version Recommendation

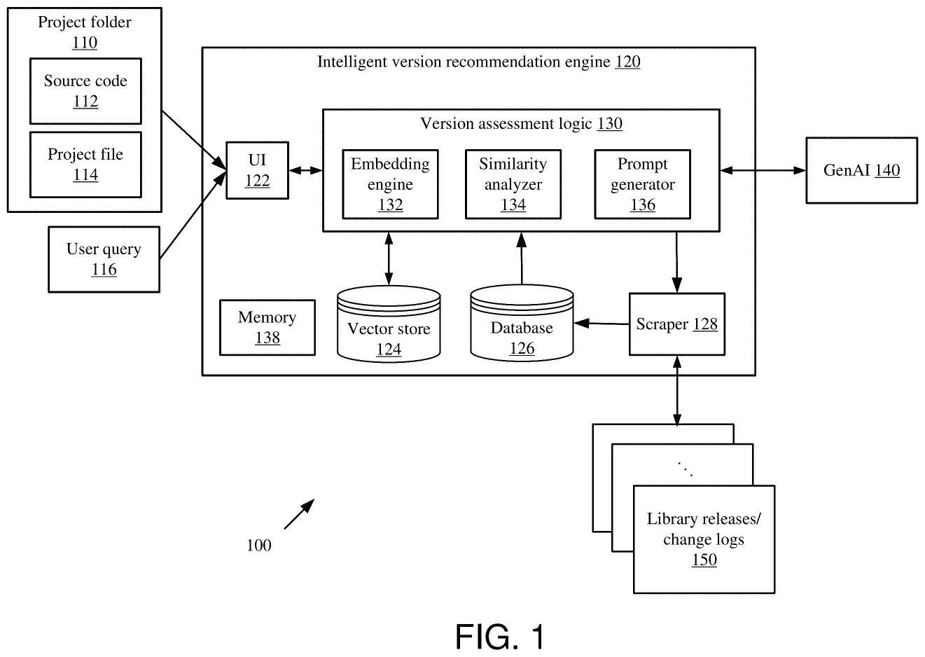

FIG. 1 shows an overall block diagram of an example intelligent version recommendation system 100 configured for intelligent version recommendation for software, particularly for FOSS.

The intelligent version recommendation system 100 includes an intelligent version recommendation engine 120 configured to automatically determine whether a software, or components of a software can be safely updated to newer versions without introducing breaking changes or incompatibilities. Specifically, the intelligent version recommendation engine 120 can identify potential issues that could arise from the update and provide detailed and actional recommendations to developers.

As shown in FIG. 1, the intelligent version recommendation engine 120 includes a user interface 122 (or “UI”), a version assessment logic 130 (or “VAL”), a database 126, a vector store 124, and a scraper 128. In some examples, the intelligent version recommendation engine 120 can also include an in-memory storage, or simply memory 138, such as a cache memory which can temporarily store frequently accessed data to accelerate retrieval times during analyses (e.g., compared to data access from the database 126). The version assessment logic 130 includes an embedding engine 132, a similarity analyzer 134, and a prompt generator 136.

Through the user interface 122, the intelligent version recommendation engine 120 can receive a user input indicating which software or dependent libraries of a software are to be analyzed for updates. As described herein, a dependent library is a collection of code that supports the functionality of a software by providing reusable functions, classes, or modules necessary for the software's operation. In response to the user input, the intelligent version recommendation engine 120 can process the input and provide detailed analysis and recommendations regarding the compatibility and potential issues associated with the updates.

In some examples, an end user's project folder 110 for a software project, which contains all the files and resources related to building a specific software, can be provided as input. For example, the project folder 110 can include source code 112 of the software, as well as a project file 114. As described herein, the project file 114 refers to a configuration file that manages the dependencies of the software project by specifying versions of dependent libraries used by the software. Example project files can be package.json for Node.js projects, pom.xml for Java Maven projects, or requirements.txt for Python projects.

In some examples, a user query 116, written in natural language, can also be provided to the user interface 122. The user query 116 can directly ask the intelligent version recommendation engine 120 whether certain software upgrade can be performed without issues. For instance, one example user query can be, “Can upgrading from library X version 1 to version 2 cause a breaking change?”

Following the user input, the intelligent version recommendation engine 120 can automatically retrieve metadata for each dependent library used by the software. This metadata may include detailed information about the dependent library originally sourced from external repositories, such as library release notes and change logs 150, typically hosted on various websites. For example, the intelligent version recommendation engine 120 can use the scraper 128 to extract the metadata directly from these sources and store it in the database 126. Consequently, after the initial scraping, metadata of the dependent library can be accessed directly from the database 126, in runtime, for subsequent analyses, removing the need to continuously scrape external sites.

As described herein, metadata gathered for each dependent library includes change logs, which provide text descriptions of modifications, fixes, and enhancements for each library version. Additionally, the metadata may contain commit information. A “commit” refers to a saved change in the library's source code, which can be represented by a unique commit object. Each commit object can include a commit hash, a timestamp, and a commit message summarizing the purpose of the modification. Sometimes, a commit object may also be associated with a source code snippet specific to the change, referred to as a “commit code snippet.” Thus, metadata of each dependent library provides a detailed record of version changes, including the specific updates and code modifications introduced over time, which can aid in assessing potential compatibility and stability impacts for software relying on these libraries.

To ensure the metadata remains current and accurately reflects the latest updates, the scraper 128 can be configured to perform automated, scheduled scrapes of external sources (e.g., daily, weekly, or the like). These scheduled updates enable the intelligent version recommendation engine 120 to maintain an up-to-date database 126, ensuring that analyses of dependent libraries consider the latest available information, including the latest commits and release notes.

In addition to storing metadata of dependent libraries used by a software project, the database 126 can also record each dependent library's usage within the source code 112 of the software project. Specifically, the database 126 can save information on the locations and context where the software invokes or utilizes the dependent libraries, capturing these interactions in the form of code snippets, also referred to as “source code snippets.” Thus, the intelligent version recommendation engine 120 not only tracks versions of dependent libraries, but also captures the integration of these dependent libraries within the project's codebase.

To facilitate effective analyses, the embedding engine 132 within the version assessment logic 130 can be used to generate vector embeddings for the metadata of each dependent library, as well as for each instance of the dependent library's usage in the project's source code. A vector embedding is a numerical representation of text (including source code), structured in a high-dimensional space where similar data points are positioned close to each other. By embedding metadata (such as change logs, commit messages, and commit code snippets) and source code usage of dependent libraries, the embedding engine 132 enables complex data to be queried semantically, allowing embeddings with similar content or usage patterns to be positioned near each other in the vector space.

These vector embeddings, once generated, can be stored in the vector store 124, which organizes and preserves vector embeddings related to source code snippets, commit code snippets, change logs, and commit messages in a structured format optimized for semantic queries. The vector store 124 enables efficient similarity-based queries by allowing the version assessment logic 130 to retrieve information based on semantic relevance rather than exact matches.

The similarity analyzer 134 can leverage the vector store 124 to measure semantic similarity between vectors. For example, if a new commit introduces code changes to a dependent library, the similarity analyzer 134 can semantically compare these new changes with the project's existing source code snippets, assessing potential impacts or verifying compatibility. Additionally, the similarity analyzer 134 can be used to identify similar patterns in application programming interface (API) changes across different libraries, providing valuable insights into how analogous modifications could affect the project overall.

The prompt generator 136 within the version assessment logic 130 is configured to facilitate informed and context-aware analysis by automatically generating prompts for a generative AI model 140 (or “GenAI model”). In some examples, the generative AI model 140 can be hosted externally, e.g., on a third-party platform. In other examples, the generative AI model 140 can be deployed locally, e.g., on the intelligent version recommendation engine 120. If the software has multiple dependent libraries, the prompt generator 136 can create a distinct prompt for each dependent library, allowing the generative AI model 140 to independently assess each dependency for potential issues associated with updates.

To generate a prompt, the prompt generator 136 can utilize a prompt template containing one or more placeholders for contextual information. These placeholders can be dynamically populated with selected metadata related to the dependent library in question. For example, relevant metadata may include change logs for the latest version of the dependent library and specific commit code snippets associated with recent modifications. Additionally, the placeholders can incorporate details of the library's current usage in the software project, such as the current version and corresponding source code snippets where the library is invoked. This ensures that each generated prompt is enriched with precise, up-to-date information on both the dependent library's recent updates and its integration within the software.

Once the prompt is populated with context, the version assessment logic 130 sends it to the generative AI model 140. This prompt instructs the generative AI model 140 to assess whether updating the dependent library from its current version to the latest version may introduce failure modes (e.g., unexpected behaviors, crashes, or broken functionality) or compatibility issues in the software project. By embedding specific details—such as recent changes in the library's code and exact points of usage within the software project—the prompt generator 136 provides the generative AI model 140 with relevant contextual information to enhance the accuracy and relevance of its assessment. The response generated by the generative AI model 140 is then returned to the version assessment logic 130, which can format the response as needed and present it on the user interface 122, allowing the user to view potential risks or compatibility insights in a clear, actionable format.

In some examples, the intelligent version recommendation engine 120 can leverage the memory 138 to prefetch or load the most frequently accessed metadata of dependent libraries. By temporarily storing such high-demand data in memory 138, the intelligent version recommendation engine 120 can achieve faster metadata retrieval (compared to accessing data directly from the database 126) and significantly reduce response times.

In practice, the systems shown herein, such as the intelligent version recommendation system 100, can vary in complexity, with additional functionality, more complex components, and the like. For example, there can be additional functionality within the intelligent version recommendation engine 120. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The intelligent version recommendation system 100 and any of the other systems described herein can be implemented in conjunction with any of the hardware components described herein, such as the computing systems described below (e.g., processing units, memory, and the like). In any of the examples herein, dependent libraries, metadata, code snippets, change logs, prompts, and the like can be stored in one or more computer-readable storage media or computer-readable storage devices. The technologies described herein can be generic to the specifics of operating systems or hardware and can be applied in any variety of environments to take advantage of the described features.

### Example Overall Method for Intelligent Version Recommendation

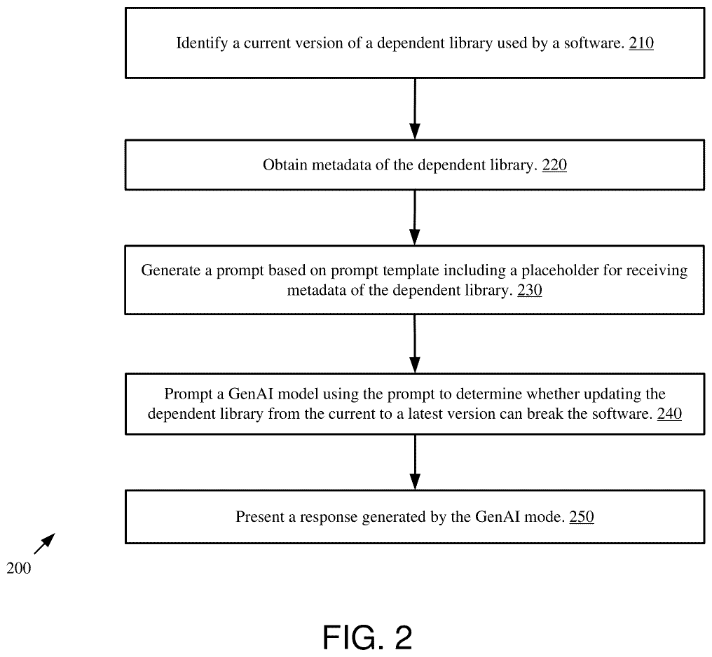

FIG. 2 is a flowchart illustrating an example overall method 200 for intelligent version recommendation for a software. The method 200 can be performed, e.g., by the intelligent version recommendation system 100 of FIG. 1.

At step 210, the method can identify, based on an input received from a user interface (e.g., the user interface 122), a current version of a dependent library used by a given software.

At step 220, the method can obtain, in runtime, metadata of the dependent library. The metadata includes one or more change logs of the dependent library. The one or more change logs include descriptions of a latest version of the dependent library.

In some examples, the method can retrieve the metadata of the dependent library from a source location (e.g., the library release notes and change logs 150), and store the metadata of the dependent library in a database (e.g., the database 126).

In some examples, retrieving and storing the metadata can be performed periodically based on a predefined schedule.

In some examples, the input can specify a project file (e.g., project file 114) of the given software. The operation of identifying the dependent library can include parsing the project file to generate a web address associated with the dependent library based on one or more fields specified in the project file.

In some examples, the operation of retrieving the metadata can be performed by a scraper (e.g., the scraper 128), which can trace, from a website identified by the web address, to the source location.

In some examples, the method can maintain a counter for total usage of the dependent library by a plurality of software including the given software. The operation of obtaining the metadata can include loading the metadata from the database to a cache memory (e.g., the memory 138) based on evaluating the counter and retrieving the metadata from the cache memory.

At step 230, the method can generate, in runtime, a prompt based on a prompt template. The prompt template includes a placeholder for receiving metadata of the dependent library.

In some examples, the metadata populating the placeholder includes a change log associated with the latest version of the dependent library. The change log can include descriptions about modifications, bug fixes, and/or enhancements introduced in the latest version of the dependent library.

In some examples, the method can identify a source code snippet in the given software that invokes the dependent library and compare semantic similarity between the source code snippet and commit code snippets included in the metadata.

In some examples, the method can convert the commit code snippet into a first embedded vector and convert the source code snippet into a second embedded vector. By representing each code snippet as an embedded vector, the method can quantitatively assess their semantic similarity. For example, the method can measure similarity using cosine similarity, which evaluates how closely related the vectors are within the embedding space. When there are multiple commit code snippets associated with the dependent library, the metadata populating the placeholder can include both the source code snippet and the top N most similar commit code snippets, where N is a predefined integer. This allows the method to identify the most relevant code modifications in the dependent library that may impact its usage in the software.

In some examples, generating the prompt includes composing a text string for populating or replacing the placeholder. The text string can include a change log associated with the latest version of the dependent library, the source code snippet, and one or more commit code snippets that are determined to be similar to the source code snippet.

At step 240, the method can prompt, in runtime, a generative AI model using the prompt to determine whether updating the dependent library from the current version to the latest version can cause a failure mode of the given software.

Then at step 250, the method can present a response generated by the generative AI model on the user interface.

In some examples, the dependent library is one of a plurality of dependent libraries used by the given software. The operations of obtaining metadata (step 220), generating the prompt (step 230), prompting the generative AI model (step 240), and presenting the response (step 250) can be iteratively performed for the plurality of dependent libraries used by the given software.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Overview of LLMs and Prompts

Generative AI models, foundation models, and LLMs are interconnected concepts in the field of AI. Generative AI, a broad term, encompasses AI systems that generate content such as text, images, music, or code. Unlike discriminative AI models that aim to make decisions or predictions based on input data features, generative AI models focus on creating new data points. Foundation models are a subset of these generative AI models, serving as a starting point for developing more specialized models. LLMs, a specific type of generative AI, work with language and can understand and generate human-like text. In the context of generative AI, including LLMs, a prompt serves as an input or instruction that informs the AI of the desired content, context, or task. This allows users to guide the AI to produce tailored responses, explanations, or creative content based on the provided prompt.

In any of the examples herein, an LLM can take the form of an AI model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI, Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

In any of the examples herein, prompts can be provided, in runtime, to LLMs to generate responses. Prompts in LLMs can be input instructions that guide model behavior. Prompts can be textual cues, questions, or statements that users provide to elicit desired responses from the LLMs. Prompts can act as primers for the model's generative process. Sources of prompts can include user-generated queries, predefined templates, or system-generated suggestions. Technically, prompts are tokenized and embedded into the model's input sequence, serving as conditioning signals for subsequent text generation. Experiment with prompt variations can be performed to manipulate output, using techniques like prefixing, temperature control, top-K sampling, chain-of-thought, etc. These prompts, sourced from diverse inputs and tailored strategies, enable users to influence LLM-generated content by shaping the underlying context and guiding the neural network's language generation. For example, prompts can include instructions and/or examples to encourage the LLMs to provide results in a desired style and/or format.

### Example Architecture of LLM

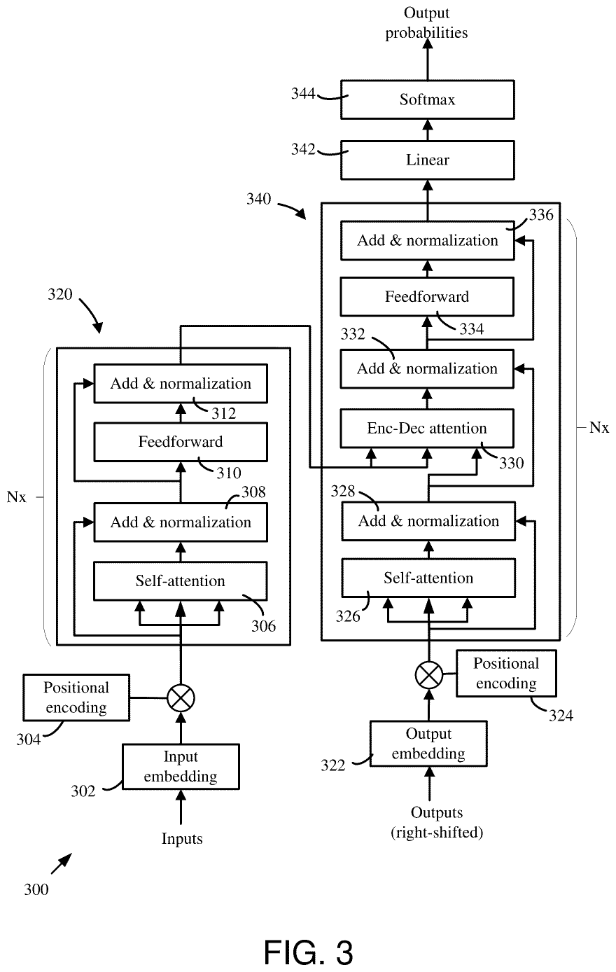

FIG. 3 shows an example architecture of an LLM 300, which can be used as the generative AI model 140 of FIG. 1.

In the depicted example, the LLM 300 uses an autoregressive model (as implemented in OpenAI's GPT) to generate text content by predicting the next word in a sequence given the previous words. The LLM 300 can be trained to maximize the likelihood of each word in the training dataset, given its context.

As shown in FIG. 3, the LLM 300 can have an encoder 320 and a decoder 340, the combination of which can be referred to as a “transformer.” The encoder 320 processes input text, transforming it into a context-rich representation. The decoder 340 takes this representation and generates text output.

For autoregressive text generation, the LLM 300 generates text in order, and for each word it generates, it relies on the preceding words for context. During training, the target or output sequence, which the model is learning to generate, is presented to the decoder 340. However, the output is right shifted by one position compared to what the decoder 340 has generated so far. In other words, the model sees the context of the previous words and is tasked with predicting the next word. As a result, the LLM 300 can learn to generate text in a left-to-right manner, which is how language is typically constructed.

Text inputs to the encoder 320 can be preprocessed through an input embedding unit 302. Specifically, the input embedding unit 302 can tokenize a text input into a sequence of tokens, each of which represents a word or part of a word. Each token can then be mapped to a fixed-length vector known as an input embedding, which provides a continuous representation that captures the meaning and context of the text input. Likewise, to train the LLM 300, the targets or output sequences presented to the decoder 340 can be preprocessed through an output embedding unit 322. Like the input embedding unit 302, the output embedding unit 322 can provide a continuous representation, or output embedding, for each token in the output sequences.

Generally, the vocabulary in LLM 300 is fixed and is derived from the training data. The vocabulary in LLM 300 consists of tokens generated above during the training process. Words not in the vocabulary cannot be output. These tokens are strung together to form sentences in the text output.

In some examples, positional encodings (e.g., 304 and 324) can be performed to provide sequential order information of tokens generated by the input embedding unit 302 and output embedding unit 322, respectively. Positional encoding is needed because the transformer, unlike recurrent neural networks, process all tokens in parallel and do not inherently capture the order of tokens. Without positional encoding, the model would treat a sentence as a collection of words, losing the context provided by the order of words. Positional encoding can be performed by mapping each position/index in a sequence to a unique vector, which is then added to the corresponding vector of input embedding or output embedding. By adding positional encoding to the input embedding, the model can understand the relative positions of words in a sentence. Similarly, by adding positional encoding to the output encoding, the model can maintain the order of words when generating text output.

Each of the encoder 320 and decoder 340 can include multiple stacked or repeated layers (denoted by Nx in FIG. 3). The number of stacked layers in the encoder 320 and/or decoder 340 can vary depending on the specific LLM architecture. Generally, a higher “N” typically means a deeper model, which can capture more complex patterns and dependencies in the data but may require more computational resources for training and inference. In some examples, the number of stacked layers in the encoder 320 can be the same as the number of stacked layers in the decoder 340. In other examples, the LLM 300 can be configured so that the encoder 320 and decoder 340 can have different numbers of layers. For example, a deeper encoder (more layers) can be used to better capture the input text's complexities while a shallower decoder (fewer layers) can be used if the output generation task is less complex).

The encoder 320 and the decoder 340 are related through shared embeddings and attention mechanisms, which allow the decoder 340 to access the contextual information generated by the encoder 320, enabling the LLM 300 to generate coherent and contextually accurate responses. In other words, the output of the encoder 320 can serve as a foundation upon which the decoder network can build the generated text.

Both the encoder 320 and decoder 340 comprise multiple layers of attention and feedforward neural networks. An attention neural network can implement an “attention” mechanism by calculating the relevance or importance of different words or tokens within an input sequence to a given word or token in an output sequence, enabling the model to focus on contextually relevant information while generating text. In other words, the attention neural network plays “attention” on certain parts of a sentence that are most relevant to the task of generating text output. A feedforward neural network can process and transform the information captured by the attention mechanism, applying non-linear transformations to the contextual embeddings of tokens, enabling the model to learn complex relationships in the data and generate more contextually accurate and expressive text.

In the example depicted in FIG. 3, the encoder 320 includes an intra-attention or self-attention neural network 306 and a feedforward neural network 310, and the decoder 340 includes a self-attention neural network 326 and a feedforward neural network 334. The self-attention neural networks 306, 326 allow the LLM 300 to weigh the importance of different words or tokens within the same input sequence (self-attention in the encoder 320) and between the input and output sequences (self-attention in the decoder 340), respectively.

In addition, the decoder 340 also includes an inter-attention or encoder-decoder attention neural network 330, which receives input from the output of the encoder 320. The encoder-decoder attention neural network 330 allows the decoder 340 to focus on relevant parts of the input sequence (output of the encoder 320) while generating the output sequence. As described below, the output of the encoder 320 is a continuous representation or embedding of the input sequence. By feeding the output of the encoder 320 to the encoder-decoder attention neural network 330, the contextual information and relationships captured in the input sequence (by the encoder 320) can be carried to the decoder 340. Such connection enables the decoder 340 to access to the entire input sequence, rather than just the last hidden state. Because the decoder 340 can attend to all words in the input sequence, the input information can be aligned with the generation of output to improve contextual accuracy of the generated text output.

In some examples, one or more of the attention neural networks (e.g., 306, 326, 330) can be configured to implement a single head attention mechanism, by which the model can capture relationships between words in an input sequence by assigning attention weights to each word based on its relevance to a target word. The term “single head” indicates that there is only one set of attention weights or one mechanism for capturing relationships between words in the input sequence. In some examples, one or more of the attention neural networks (e.g., 306, 326, 330) can be configured to implement a multi-head attention mechanism, by which multiple sets of attention weights, or “heads,” in parallel to capture different aspects of the input sequence. Each head learns distinct relationships and dependencies within the input sequence. These multiple attention heads can enhance the model's ability to attend to various features and patterns, enabling it to understand complex, multi-faceted contexts, thereby leading to more accurate and contextually relevant text generation. The outputs from multiple heads can be concatenated or linearly combined to produce a final attention output.

As depicted in FIG. 3, both the encoder 320 and the decoder 340 can include one or more addition and normalization layers (e.g., the layers 308 and 312 in the encoder 320, the layers 328, 332, and 336 in the decoder 340). The addition layer, also known as a residual connection, can add the output of another layer (e.g., an attention neural network or a feedforward network) to its input. After the addition operation, a normalization operation can be performed by a corresponding normalization layer, which normalizes the features (e.g., making the features to have zero mean and unit variance), This can help in stabilizing the learning process and reducing training time.

A linear layer 342 at the output end of the decoder 340 can transform the output embeddings into the original input space. Specifically, the output embeddings produced by the decoder 340 are forwarded to the linear layer 342, which can transform the high-dimensional output embeddings into a space where each dimension corresponds to a word in the vocabulary of the LLM 300.

The output of the linear layer 342 can be fed to a softmax layer 344, which is configured to implement a softmax function, also known as softargmax or normalized exponential function, which is a generalization of the logistic function that compresses values into a given range. Specifically, the softmax layer 344 takes the output from the linear layer 342 (also known as logits) and transforms them into probabilities. These probabilities sum up to 1, and each probability corresponds to the likelihood of a particular word being the next word in the sequence. Typically, the word with the highest probability can be selected as the next word in the generated text output.

Still referring to FIG. 3, the general operation process for the LLM 300 to generate a reply or text output in response to a received prompt input is described below.

First, the input text is tokenized, e.g., by the input embedding unit 302, into a sequence of tokens, each representing a word or part of a word. Each token is then mapped to a fixed-length vector or input embedding. Then, positional encoding 304 is added to the input embeddings to retain information regarding the order of words in the input text.

Next, the input embeddings are processed by the self-attention neural network 306 of the encoder 320 to generate a set of hidden states. As described above, multi-head attention mechanism can be used to focus on different parts of the input sequence. The output from the self-attention neural network 306 is added to its input (residual connection) and then normalized at the addition and normalization layer 308.

Then, the feedforward neural network 310 is applied to each token independently. The feedforward neural network 310 includes fully connected layers with non-linear activation functions, allowing the model to capture complex interactions between tokens. The output from the feedforward neural network 310 is added its input (residual connection) and then normalized at the addition and normalization layer 312.

The decoder 340 uses the hidden states from the encoder 320 and its own previous output sequence to generate the next token in an autoregressive manner so that the sequential output is generated by attending to the previously generated tokens. Specifically, the output of the encoder 320 (input embeddings processed by the encoder 320) are fed to the encoder-decoder attention neural network 330 of the decoder 340, which allows the decoder 340 to attend to all words in the input sequence. As described above, the encoder-decoder attention neural network 330 can implement a multi-head attention mechanism, e.g., computing a weighted sum of all the encoded input vectors, with the most relevant vectors being attributed the highest weights.

The previous output sequence of the decoder 340 is first tokenized by the output embedding unit 322 to generate an output embedding for each token in the output sequence. Similarly, positional embedding 324 is added to the output embedding to retain information regarding the order of words in the output sequence.

The output embeddings are processed by the self-attention neural network 326 of the decoder 340 to generate a set of hidden states. The self-attention mechanism allows each token in the text output to attend to all tokens in the input sequence as well as all previous tokens in the output sequence. The output from the self-attention neural network 326 is added to its input (residual connection) and then normalized at the addition and normalization layer 328.

The encoder-decoder attention neural network 330 receives the output embeddings processed through the self-attention neural network 326 and the addition and normalization layer 328. Additionally, the encoder-decoder attention neural network 330 also receives the output from the addition and normalization layer 312 which represents input embeddings processed by the encoder 320. By considering both processed input embeddings and output embeddings, the output of the encoder-decoder attention neural network 330 represents an output embedding which takes into account both the input sequence and the previously generated outputs. As a result, the decoder 340 can generate the output sequence that is contextually aligned with the input sequence.

The output from the encoder-decoder attention neural network 330 is added to part of its input (residual connection), i.e., the output from the addition and normalization layer 328, and then normalized at the addition and normalization layer 332. The normalized output from the addition and normalization layer 332 is then passed through the feedforward neural network 334. The output of the feedforward neural network 334 is then added to its input (residual connection) and then normalized at the addition and normalization layer 336.

The processed output embeddings output by the decoder 340 are passed through the linear layer 342, which maps the high-dimensional output embeddings back to the size of the vocabulary, that is, it transforms the output embeddings into a space where each dimension corresponds to a word in the vocabulary. The softmax layer 344 then converts output of the linear layer 342 into probabilities, each of which corresponds to the likelihood of a particular word being the next word in the sequence. Finally, the LLM 300 samples an output token from the probability distribution generated by the softmax layer 344 (e.g., selecting the token with the highest probability), and this token is added to the sequence of generated tokens for the text output.

The steps described above are repeated for each new token until an end-of-sequence token is generated or a maximum length is reached. Additionally, if the encoder 320 and/or decoder 340 have multiple stacked layers, the steps performed by the encoder 320 and decoder 340 are repeated across each layer in the encoder 320 and the decoder 340 for generation of each new token.

### Example Dependent Libraries

In many software projects, a project file—such as pom.xml for Maven in Java projects—serves as a dependency descriptor file, detailing the external libraries (also referred to as “dependent libraries”) or frameworks required for the software to function correctly. Generally, the project file holds information about each dependent library's specific version, configuration settings, and, in some cases, usage scope within the project. By listing dependencies explicitly, project files enable seamless dependency management, ensuring that software has access to all necessary components without embedding them directly within the source code.

Dependencies, in this context, refer to dependent libraries or modules the software relies on for additional functionality or pre-built components, like testing frameworks or utility libraries. For instance, in a Java Maven project, a dependency file might specify a plurality of dependent libraries, one of which can be xmlunit, which supports XML testing. An example listing for xmlunit is as follows:

```
<!-- https://mvnrepository.com/artifact/org.xmlunit/xmlunit-core -->
<dependency>
  <groupId>org.xmlunit</groupId>
  <artifactId>xmlunit-core</artifactId>
  <version>2.9.1</version>
  <scope>test</scope>
</dependency>
```

This example specifies the dependent library's group ID (org.xmlunit), artifact ID (xmlunit-core), version (2.9.1), and usage scope (for testing).

### Example Scraping

As described above, for each dependent library, the intelligent version recommendation engine can utilize a scraper to gather relevant metadata—such as release notes, change logs, and committed code snippets—from corresponding websites. This metadata is then stored in a database, enabling efficient and rapid access during subsequent analyses.

In an example scraping process using the XMLUnit library described above, the intelligent version recommendation engine's scraper begins by parsing the project file, such as pom.xml, to locate the dependent library's details, here identified as xmlunit-core with version 2.9.1. From this information, the scraper constructs the appropriate web link to the library's page on the Maven repository. For example, using the group ID org.xmlunit, the artifact ID xmlunit-core, and the version number 2.9.1, the scraper constructs the URL https://mvnrepository.com/artifact/org.xmlunit/xmlunit-core/2.9.1.

Further details about this library's origin, as indicated on the Maven repository page, include a homepage URL (https://www.xmlunit.org). By visiting this page, the scraper can identify additional resources, such as development details or the GitHub repository where XMLUnit's development and release notes are documented. Navigating to the GitHub repository, the scraper module could access the library's release information. For instance, by querying https://api.github.com/repos/xmlunit/xmlunit/releases, the scraper can retrieve release notes detailing recent modifications, enhancements, and version histories. Likewise, the scraper can extract specific commit information relevant to the library's files, such as TransformerFactory.java, using curl-H “Accept: application/vnd.github.v3+json” https://api.github.com/repos/xmlunit/xmlunit/commits?path=TransformerFactory.java.

### Example Change Logs

As examples, the following shows change logs associated with three different versions of the XMLUnit library.

XMLUnit for Java 2.10.0
add a new ElementSelectors.byNameAndAllAttributes variant that filters attributes
before deciding whether elements can be compared.
Inspired by Issue #259
By default the TransformerFactorys created will now try to disable extension functions.
If you need extension functions for your transformations you may want to pass in your
own instance of TransformerFactory and TransformerFactoryConfigurer may help with
that.
Inspired by Issue #264
JAXPXPathEngine will now try to disable the execution of extension functions by
default but uses XPathFactory#setProperty which is not available prior to Java 18. You
may want to enable secure processing on an XPathFactory instance you pass to
JAXPXPathEngine instead - and XPathFactoryConfigurer may help with that.
XMLUnit for Java 2.9.1
fixed some AssertJ tests that didn't work on Windows.
Issue #252 and PR #253 by @Boiarshinov
added overloads to ElementSelectors.byXPath that accept a XPathEngine argument.
Issue #255
added Cyclone DX SBOMs to release artifacts
XMLUnit for Java 2.9.0
The major change of XMLUnit for Java 2.9.0 is the addition of a new module xmlunit-
jakarta-jaxb-impl that can be used in addition to xmlunit-core when you want to use the
Jakarta XML Binding API in version 3. For details please see the user's guide.
The full list of changes of XMLUnit for Java 2.9.0 is:
added a new module xmlunit-jakarta-jaxb-impl that makes Input.fromJaxb use
jakarta.xml.bind rather than javax.xml.bind. For more details see the User's Guide.
This change is not fully backwards compatible. The JaxbBuilder class has become
abstract and the withMarshaller method has changed its signature. For most cases the
change will not be noticed and for almost all other cases it should be enough to re-
compile your code against XMLUnit 2.9.x.
Issue #227 and PR #247
added NodeFilters#satisfiesAll and satifiesAny methods to make it easier to combine
multiple node filters. added to simplify the use case of #249

Based on the detailed changelogs for XMLUnit library versions, upgrading between versions could lead to breaking changes in dependent projects due to modifications in core functionalities and compatibility constraints. For instance, in XMLUnit version 2.9.0, the addition of the xmlunit-jakarta-jaxb-impl module introduced incompatibility with earlier versions, which is highlighted in the changelog. This module update also caused the JaxbBuilder class to become abstract, requiring dependent projects using earlier versions to recompile their code against XMLUnit 2.9.x to maintain compatibility.

In a similar vein, version 2.10.0 introduced changes in TransformerFactory that affect how extension functions are handled. Where earlier versions had extension functions enabled by default, 2.10.0 disabled these by default, meaning projects reliant on the prior extension functionality must explicitly adapt their code to re-enable these functions or provide their own TransformerFactory instance. For a project using version 2.9.1, which relies on TransformerFactory methods with extensions enabled, an upgrade to 2.10.0 would necessitate code modifications to ensure compatibility. Note that the TransformerFactory method is only one of several potential changes in XMLUnit; thus, projects must carefully assess other library functions that might also have altered behavior in newer versions, as each can introduce additional breaking changes.

### Example Storage of Metadata and Source Projects

Fetched metadata for a library can be stored in a database, such as MongoDB. An example schema for storing the library metadata is as follows (collection name: library_data):

| Column Name | Description |
|---|---|
| _id | Unique identifier for the library (e.g., combination |
| | of library name and version). |
| library_name | The name of the library (e.g., xmlunit). |
| version | The version of the library (e.g., 2.10.0). |
| changelog | Detailed change log for the version. |
| commits | Array of commit objects with commit hashes, |
| | timestamps, and commit messages. |
| commit_source_{—} | Array of source code snippets related to the |
| code | commits. |
| source_code_files | File paths of the source code in the library |
| | repository. |
| repository_url | URL to the GitHub repository. |
| retrieval_{—} | The timestamp when the data was retrieved. |
| timestamp | |

An example record saved in the database based on the above schema is listed below:

```
{
  “_id”: “xmlunit_2.10.0”, “library_name”: “xmlunit”, “version”: “2.10.0”,
  “changelog”: “Fixed bug in Transformer Factory method...”, “commits”: [
    {
      “commit_hash”: “abc123”, “timestamp”: “2024-08-13T12:00:00Z”,
      “commit_message”: “Fix issue with Transformer Factory ”
    }
  ],
  “commit_source_code”: [
    {
      “commit_hash”: “abc123”,
      “file_path”: “src/transformerFactory.js”,
      “code”: “function transform(array, iteratee) { ... }”
    }
  ],
  “source_code_files”: [
      “src/transformerFactory.java”,
      “src/parse.java”
  ],
  “repository_url”: “https://github.com/xmlunit/xmlunit”,
  “retrieval_timestamp”: “2024-08-13T12:00:00Z”
}
```

As described above, the library's usage in the source code of the software project can also be stored in the database. This information can be used to evaluate the potential impact of version upgrades on the project by pinpointing the exact locations in the code (e.g., line number of a specific source file) where the library is invoked. An example schema for storing the project source code usage is as follows (collection name: project_code_usage):

| Column Name | Description |
|---|---|
| _id | Unique identifier for the project (e.g., project name). |
| library_name | The name of the library (e.g., lodash). |
| version_used | The version of the library currently used in the project. |
| file_usages | Array of objects, each representing a file where the |
| | library is used. |
| file_path | Path to the file in the project. |
| code_snippets | Array of code snippets where the library is used, along |
| | with line numbers. |
| package_{—} | Package manager used (e.g., maven, npm). |
| manager | |

An example record saved in the database based on the above schema is listed below:

```
{
  “_id”: “project123”,
  “library_name”: “xmlunit”,
  “version_used”: “2.9.1”,
  “file_usages”: [
    {
      “file_path”: “src/utils.js”,
      “code_snippets”: [
        {
          “code”: “const result = _.transform([1, 2, 3], n => n * 2);”,
          “line_number”: 12
        }
      ]
    }
  ],
  “package_manager”: “npm”
}
```

### Example Vector Embeddings and Code Comparison

As described above, retrieved project metadata, including change logs, commits, and commit code snippets associated with a dependent library can be converted into vector embeddings and stored in a vector store. An example pseudo-code for generate vector embeddings is listed below:

```
  from sentence_transformers import SentenceTransformer.
  # Load a pre-trained model for generating embeddings
  model = SentenceTransformer(‘paraphrase-MiniLM-L6-v2’)
  # Example changelog
  changelog_text = “_.transform has been deprecated and replaced
by_.transformParse.”
  # Generate embedding
  embedding = model.encode(changelog_text)
  # Store in the vector store
  vector_db.store({
    “library_name”: “xmlunit”,
    “version”: “2.10.0”,
    “commit_hash”: “abcd1234”,
    “text”: changelog_text,
    “embedding”: embedding
  })
```

The embedding process can be repeated for each change log, commit, and relevant commit code snippet associated with the dependent library. An example schema for storing vector embedding corresponding to the library metadata can be as follows:

```
{
  “library_name”: “xmlunit”,
  “version”: “2.10.0”,
  “commit_hash”: “abcd1234”,
  “text”: “_.transform has been deprecated and replaced by
  _.transformParse.”,
  “embedding”: [
    0.25,
    0.76,
    −0.34, ...,
    0.12
  ] // The embedding vector
}
```

Similarly, software project's source code snippets representing usage of the dependent library can also be converted into vector embeddings and saved in the vector store, as illustrated by the following example pseudo-code:

```
# Example project source code snippet
project_code_snippet = “const result = _.transform([1, 2, 3], n => n *
2);”
# Generate embedding for the project code
project_embedding = model.encode(project_code_snippet)
# Store in the vector store
vector_db.store({
  “project_name”: “user_project”,
  “file_path”: “src/utils.js”,
  “line_number”: 12,
  “code”: project_code_snippet,
  “embedding”: project_embedding
})
```

An example schema for storing vector embedding corresponding to the project's usage of the dependent library can be as follows:

```
{
  “project_name”: “user_project”,
  “file_path”: “src/utils.js”,
  “line_number”: 12,
  “code”: “const result = _.map([1, 2, 3], n => n * 2);”,
  “embedding”: [
    0.23,
    0.89,
    −0.31, ...,
    0.14
  ] // The embedding vector
}
```

### Example Prompt Context

As described above, the version assessment logic of the intelligent version recommendation engine can generate a prompt that will be sent to the generative AI model. This prompt will instruct the generative AI model to assess whether updating a library from one version to another may introduce a failure mode in the software that relies on that library. The prompt can be generated using a predefined prompt template which includes at least one placeholder for relative contextual information, such as the library name, versions, change logs, commit code snippets, and source code snippets from the user's software project.

Depending on use cases, the prompt can be generated by selecting the prompt template from a plurality of predefined prompt templates. For example, one example prompt template might read: “Given the following library details: {context_info}, determine whether there are breaking changes to upgrade the library from its current version to the latest version.” Another prompt template may include additional constraints, such as: “Given the following library details: {context_info}, determine whether there are breaking changes to upgrade the library from its current version to the latest version. Ensure that the recommendations are production-safe and code-friendly. Consider the constraints-Avoid suggesting deprecated methods. Ensure that recommended changes align with the best practices and Include examples wherever applicable.” Yet another prompt template may include additional instructions for generating recommendations of code changes, e.g., “Analyze the following details of a library upgrade: {context_info}. Identify any breaking changes between the current and latest versions. Provide code snippets to guide the developer on how to fix or mitigate the issues.” A further example prompt template can be: “As an AI code consultant, analyze the following input: {context_info}. Identify breaking changes between versions and generate recommendations that are: Backward compatible, align with industry best practices, suitable for production environments, and provide code examples for mitigation.” It should be understood that the above prompt templates described above are merely examples, and other prompt templates can be constructed based on the principles described herein. For instance, instead of fitting all contextual information in one placeholder, the contextual information can be populated in multiple placeholders (e.g., one placeholder for change logs, another placeholder for source code snippets, etc.).

In some examples, the contextual information can be represented by a text string, which can be composed in runtime, as illustrated by the following example pseudo-code:

```
# Fetch library metadata and project code usage from database
  library_metadata = db.libraries.find_one({“name”: “xmlunit”, “latest_version”: True})
  project_code_usage = list(db.project_code_usage.find({“library_name”: “xmlunit”}))
# Query vector store for similar code snippets
  similar_code_snippets = vector_db.query({“embedding”: project_embedding, “top_k”: 5})
# Prepare combined text string for providing contextual info to be inserted into a prompt
  context_info = “““ Library: {library_metadata[‘name’]} Latest Version:
  {library_metadata[‘version’]} Changelog: {library_metadata[‘changelog’]}
  Project Code Usage: {“.join([f”File: {usage[‘file_path’]}, Line: {usage[‘line_number’]},
Code:
  {usage[‘code’]}\n“ for usage in project_code_usage])}
  Similar Code Snippets: {“.join([f”Version: {snippet[‘version’]}, Commit:
{snippet[‘commit_hash’]},
  Changelog: {snippet[‘text’]}\n“ for snippet in similar_code_snippets])} ”””
```

In this example, the contextual information is generated by sequentially fetching relevant data and organizing it into a structured text string. The code begins by retrieving metadata about the library, such as its name, latest version, and changelog, from the database. It also fetches detailed information on where the library is utilized within the user's project source code, including specific file paths, line numbers, and source code snippets. Additionally, it queries a vector store to locate similar code snippets based on project embeddings. This combined data is then formatted into a text string (context_info) that integrates library metadata, project code usage, and related code examples.

In some examples, the composed text string not only populates the placeholder in the prompt template but can also be used to generate a report. This report can be rendered dynamically using a template engine such as Jinja2 for Python Flask applications or with a front-end framework like React, providing a clear, structured view of the contextual information for the end user. An example HTML output of such report can be as follows:

```
‘‘‘html
<div>
  <h1>Update Report</h1>
  <h2>Summary of Changes</h2>
      <p>-_.transform has been deprecated and replaced with _.transforParse.</p>
      <h2>Affected Files</h2>
<pre> <code>
src/utils.js (line 12): const result = _.transform([1, 2, 3], n => n * 2 );
</code> </pre>
<h2>Recommended Changes</h2>
<pre> <code>
    In file src/utils.js, replace the usage of _.transform with the following
code:
      const result = _.transformParse([1, 2, 3], n => n * 2);
</code> </pre>
</div>
```

The end user can then review this report to make necessary code changes in a more efficient and time-saving manner. The solution clearly identifies any required updates when a library is upgraded to a new version, specifying exactly where and what modifications need to be made.

As described above, the prompt template can also include instructions directing the generative AI model to provide answers on recommended code changes if breaking points are expected for the library's upgraded version. This allows the intelligent version recommendation system not only to identify potential failure modes but also to proactively suggest modifications in the user's code that can mitigate or resolve these issues.

### Example Deployment, Model Fine-Tuning and Retraining

Based on the minimum viable files (MVF), such as a collection of metadata from a minimum set of dependent libraries that are used for a build a software project, it is feasible to build a starter kit of a working version of the version assessment logic or VAL application for intelligent version recommendation. The VAL application can be deployed at runtime, and it can be cached so that the MVF does not need to be rebuilt every time, thereby saving computational power and improving efficiency. As described above, contextual information (such as collected metadata of dependent libraries and usage of the libraries in the software project) can be converted into vector embeddings and saved in the vector store. After deployment, the VAL application can fetch the contextual information from the vector store, automatically compose a prompt containing the contextual information, and send the prompt to the generative AI model for getting the recommendation on how to safely and effective make changes to the source code in the user's software project where the dependent libraries are used.

In some examples, the intelligent version recommendation system can fine tune and iteratively retrain the generative AI model to improve the accuracy and effectiveness of version recommendations. Fine-tuning the pre-trained generative AI model can be performed based on user feedback, while machine learning techniques can be applied to retrain the model by analyzing patterns in project code usage and library changes.

Fine-tuning the generative AI model can enhance its ability to provide relevant recommendations tailored to the user's project context. For fine-tuning, feedback data collected from user interactions can be transformed into a labeled dataset. In some examples, the dataset can include pairs of input texts and corresponding expected outputs, along with feedback scores indicating how helpful the generative AI model's recommendations were. For instance, when users implement code changes based on the model's suggestions, the actual code they produce can be compared to the original recommendations. This feedback loop allows the generative model to learn from both successful and unsuccessful recommendations, refining its understanding of which changes are most effective for different scenarios.

The preparation of the training dataset can involve querying the database for user feedback entries. Each entry can be processed to extract the generative AI model input text string, the user-implemented code, and a feedback score. This structured data enables the model to recognize patterns in how users respond to various recommendations. After the training data is assembled, the fine-tuning can be executed, e.g., using libraries like Hugging Face's Transformers, leveraging advanced training techniques to adapt the generative AI model specifically for the intelligent version recommendation task.

The fine-tuned generative AI model can be deployed and used by the intelligent version recommendation system to provide tailored recommendations for software update. In some examples, machine learning algorithms can be employed to analyze patterns within the user's code and the associated library versions. This involves extracting features that represent critical aspects of both the project code and library changes, such as the number of function calls, deprecated methods, and newly introduced features. These features can be used to predict potential issues that may arise when upgrading to a newer library version.

For example, a Random Forest Classifier can be trained using a dataset that includes features extracted from the user's project code. This dataset can be labeled to indicate whether the existing code will break following a library update. By training the model on the historical data of library upgrades and the corresponding project adaptations, the system can gain insights into which code patterns are more likely to encounter issues during upgrades. This predictive capability can complement the generative AI model's recommendations, providing users with insights into both the risks and the necessary adjustments when upgrading their libraries.

### Example Fast Access of Metadata

In some examples, the intelligent version recommendation system disclosed herein can use an optimized usage frequency profile to track libraries that are frequently accessed across various software projects. An example schema for usage frequency profile can be as follows:

```
{
  “_id”: “ObjectId”, // Unique ID for each document
  “library_name”: “xmlunit”, // Name of the library
  “version”: “4.17.21”, // Version of the library
  “usage_count”: 120, // Number of projects using this library
  “last_accessed”: “2024-08-16T12:00:00Z” // Timestamp when this
  entry was last accessed
}
```

This feature can provide efficient metadata retrieval by evaluating how often a given library is used and preloading its metadata into an in-memory storage or cache memory, such as memory 138. Each time a library is detected in a project scan for evaluating version update of a software, a counter in the usage frequency profile is updated, reflecting its overall use across multiple software projects. This indexed counter allows the system to prioritize popular libraries, improving data access efficiency and ensuring that frequently used library metadata is always readily available. An example pseudo-code for updating the usage frequency profile is as follows:

```
  # Function to update usage frequency profile when a library is detected in a project
  def update_popularity_index(library_name, version):
      result = db.popularity_index.find_one({“library_name”: library_name, “version”:
version})
    if result:
        # If the library/version is already in the index, increment the usage count
        db.popularity_index.update_one(
          {“library_name”: library_name, “version”: version},
          {“$inc”: {“usage_count”: 1}, “$set”: {“last_accessed”: datetime.utcnow( )}}
        )
      else:
        # If not, insert a new document for the library/version
        db.popularity_index.insert_one(
          { “library_name”: library_name,
            “version”: version,
            “usage_count”: 1,
            “last_accessed”: datetime.utcnow( )
        })
```

When metadata is requested, the system first checks if the library in question is stored in the memory, a process guided by the usage frequency profile. By retrieving metadata from the memory, the system bypasses the need for repeated database queries, thereby significantly reducing query response times. Libraries with high access frequencies can be automatically loaded into the memory at application startup or periodically refreshed to ensure up-to-date information is always available. The following example pseudo-code illustrates methods for identifying most frequently accessed libraries (or “popular libraries”) based on the usage frequency profile, caching relevant metadata in memory for faster access, and fetching library metadata from the cache memory.

```
# Function to get popular libraries from the usage frequency profile
    def get_most_popular_libraries(limit=5):
# Fetch the most popular libraries, sorted by usage_count in descending order
    popular_libraries = db.popularity_index.find( ).sort(″usage_count″, −1).limit(limit)
    return list(popular_libraries)
# Example usage: Get the top 5 most popular libraries
    top_libraries = get_most_popular_libraries( )
    for library in top_libraries:
      print(f″Library: {library[′library_name′]}, Version: {library[′version′]}, Usage
Count:
    {library[′usage_count′]}″)
# Cache popular libraries in memory for faster access
  popular_library_cache = { }
  def cache_popular_libraries( ):
    popular_libraries = get_most_popular_libraries(limit=10) # Cache top 10 popular
    libraries for library in popular_libraries:
      # Fetch library details and store them in cache
      library_details = db.libraries.find_one({″name″: library[′library_name′],
″version″: library[′version′]})
      popular_library_cache[library[′library_name′]] = library_details
# Example: Call this function during application startup or periodically
    cache_popular_libraries( )
# Function to fetch library details with cache fallback
    def get_library_details(library_name, version):
    # Check if the library is in cache
    if library_name in popular_library_cache:
      return popular_library_cache[library_name]
    else:
      # If not in cache, fetch from MongoDB
      return db.libraries.find_one({″name″: library_name, ″version″: version}
# Example usage
    library_details = get_library_details(″xmlunit″, “2.10.0″)
    print(library_details)
```

In some examples, the system can proactively prefetch metadata and related information for the most-used libraries. By periodically scanning the usage frequency profile, the system can identify libraries with high usage counts and preloads their metadata, version history, and any relevant change logs into the memory. This prefetching process can minimize access delays and allow the system to deliver recommendations or fetch details on high-demand libraries without downtime. The following example pseudo-code illustrates the methods for prefetching metadata into memory:

```
# Function to prefetch library metadata
  def prefetch_popular_library_data( ):
  popular_libraries = get_most_popular_libraries(limit=10)
  for library in popular_libraries:
      # Prefetch and cache relevant data for each popular library
      library_metadata = db.libraries.find_one({
        “name”: library[‘library_name’],
        “version”: library[‘version’]})
      similar_code_snippets = vector_db.query({
        “library_name”: library[‘library_name’],
          “version”: library[‘version’]})
  # Store prefetched data in a cache or precompute recommendations
  precomputed_data_cache[library[‘library_name’]] = {
      “metadata”: library_metadata,
      “code_snippets”: similar_code_snippets
  }
# Example: Call this periodically to keep data fresh
    prefetch_popular_library_data( )
```

### Example Advantages

The technologies described herein offer several technical advantages, enhancing the efficiency, accuracy, and productivity of managing software library versions, particularly in the FOSS environment.

First, by providing context-aware recommendations, the intelligent version recommendation system disclosed herein streamlines the upgrade process by analyzing critical information such as release notes, change logs, and existing vulnerabilities associated with each library version. This comprehensive analysis enables developers to receive upgrade recommendations that are both current and tailored to their specific project needs, minimizing the likelihood of compatibility issues or breaking changes that can disrupt development timelines.

The disclosed intelligent version recommendation engine with contextual awareness enables the system to predict compatibility risks based on the unique way each library is used within a software project, including code structure and historical modifications. This reduces the manual work required for developers to assess each update, saving significant time and minimizing errors. Additionally, by automating the analysis of periodic updates of libraries, the system ensures that developers have access to the latest version information and security data, empowering them to maintain software integrity and stability more effectively.

The disclosed intelligent version recommendation engine can also increase productivity by making proactive code suggestions for managing breaking changes. By identifying specific areas of code that would be affected by an upgrade and proposing targeted fixes, the system can assist developers in adapting their codebase to newer versions seamlessly. This automation transforms what would otherwise be a labor-intensive, manual process into an optimized workflow, allowing teams to focus on high-priority tasks without compromising project stability. For example, a prototype of the system was able to generate version recommendations for a single library in approximately five minutes, compared to an estimated three hours of manual effort per library. Given that software projects often depend on dozens, hundreds, or even thousands of libraries, the potential for cumulative time savings is substantial.

Further, the system's ability to centralize and store critical versioning information, combined with its rapid response (e.g., in runtime) to user queries, provides immediate and actionable insights. Developers can quickly access details on dependency issues, version compatibility, and potential vulnerabilities, supporting informed decision-making.

### Example Computing Systems

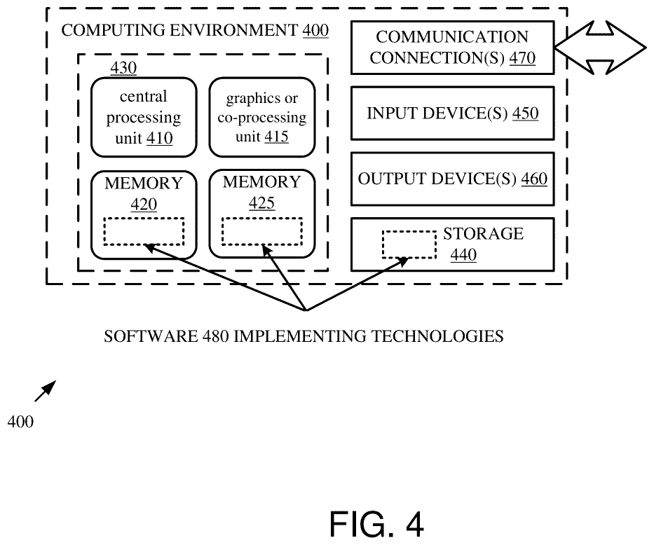

FIG. 4 depicts an example of a suitable computing system 400 in which the described innovations can be implemented. The computing system 400 is not intended to suggest any limitation as to scope of use or functionality of the present disclosure, as the innovations can be implemented in diverse computing systems.

With reference to FIG. 4, the computing system 400 includes one or more processing units 410, 415 and memory 420, 425. In FIG. 4, this basic configuration 430 is included within a dashed line. The processing units 410, 415 can execute computer-executable instructions, such as for implementing the features described in the examples herein (e.g., the method 200). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 4 shows a central processing unit 410 as well as a graphics processing unit or co-processing unit 415. The tangible memory 420, 425 can be volatile memory (e.g., registers, cache, RAM), non-volatile memory (e.g., ROM, EEPROM, flash memory, etc.), or some combination of the two, accessible by the processing unit(s) 410, 415. The memory 420, 425 can store software 480 implementing one or more innovations described herein, in the form of computer-executable instructions suitable for execution by the processing unit(s) 410, 415.

A computing system 400 can have additional features. For example, the computing system 400 can include storage 440, one or more input devices 450, one or more output devices 460, and one or more communication connections 470, including input devices, output devices, and communication connections for interacting with a user. An interconnection mechanism (not shown) such as a bus, controller, or network can interconnect the components of the computing system 400. Typically, operating system software (not shown) can provide an operating environment for other software executing in the computing system 400, and coordinate activities of the components of the computing system 400.

The tangible storage 440 can be removable or non-removable, and includes magnetic disks, magnetic tapes or cassettes, CD-ROMs, DVDs, or any other medium which can be used to store information in a non-transitory way and which can be accessed within the computing system 400. The storage 440 can store instructions for the software implementing one or more innovations described herein.

The input device(s) 450 can be an input device such as a keyboard, mouse, pen, or trackball, a voice input device, a scanning device, touch device (e.g., touchpad, display, or the like) or another device that provides input to the computing system 400. The output device(s) 460 can be a display, printer, speaker, CD-writer, or another device that provides output from the computing system 400.

The communication connection(s) 470 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

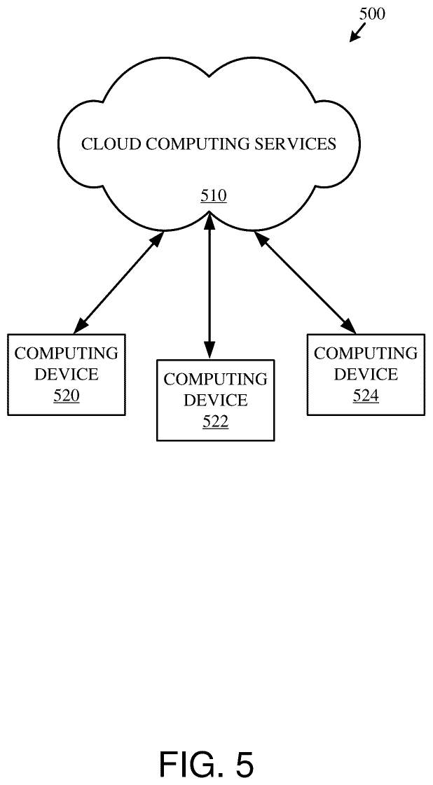

FIG. 5 depicts an example cloud computing environment 500 in which the described technologies can be implemented, including, e.g., the intelligent version recommendation system 100 and other systems herein. The cloud computing environment 500 can include cloud computing services 510. The cloud computing services 510 can comprise various types of cloud computing resources, such as computer servers, data storage repositories, networking resources, etc. The cloud computing services 510 can be centrally located (e.g., provided by a data center of a business or organization) or distributed (e.g., provided by various computing resources located at different locations, such as different data centers and/or located in different cities or countries).

The cloud computing services 510 can be utilized by various types of computing devices (e.g., client computing devices), such as computing devices 520, 522, and 524. For example, the computing devices (e.g., 520, 522, and 524) can be computers (e.g., desktop or laptop computers), mobile devices (e.g., tablet computers or smart phones), or other types of computing devices. For example, the computing devices (e.g., 520, 522, and 524) can utilize the cloud computing services 510 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (Saas), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

Although specific prompt templates are described above, it should be understood that these prompt templates are merely examples for illustration purposes, and different prompt templates can be used based on the principles described herein.

In any of the examples described herein, an operation performed in runtime or real-time means that the operation can be completed with negligible processing latency (e.g., the operation can be completed within 1 second, etc.).

### Example Clauses

Any of the following example clauses can be implemented.

Clause 1. A computing system comprising: memory; one or more hardware processors coupled to the memory; and one or more computer readable storage media storing instructions that, when loaded into the memory, cause the one or more hardware processors to perform operations comprising: identifying, based on an input received from a user interface, a current version of a dependent library used by a given software; obtaining, in runtime, metadata of the dependent library, wherein the metadata comprises one or more change logs of the dependent library, wherein the one or more change logs include descriptions of a latest version of the dependent library; generating, in runtime, a prompt based on a prompt template, wherein the prompt template includes a placeholder for receiving metadata of the dependent library; prompting, in runtime, a generative artificial intelligence (AI) model using the prompt to determine whether updating the dependent library from the current version to the latest version can cause a failure mode of the given software; and presenting a response generated by the generative AI model on the user interface.

Clause 2. The computing system of clause 1, wherein the dependent library is one of a plurality of dependent libraries used by the given software, wherein the operations of obtaining metadata, generating the prompt, prompting the generative AI model, and presenting the response are iteratively performed for the plurality of dependent libraries used by the given software.

Clause 3. The computing system of any one of clauses 1-2, wherein the operations further comprise retrieving the metadata of the dependent library from a source location; and storing the metadata of the dependent library in a database.

Clause 4. The computing system of clause 3, wherein the operations of retrieving and storing the metadata are performed periodically based on a predefined schedule.

Clause 5. The computing system of any one of clauses 3-4, wherein the input specifies a project file of the given software, wherein the operation of identifying the dependent library comprises parsing the project file, wherein the operation of retrieving the metadata comprises generating a web address associated with the dependent library based on one or more fields obtained by the parsing; and tracing, from a website identified by the web address, to the source location.

Clause 6. The computing system of any one of clauses 3-5, wherein the operations further comprise maintaining a counter for total usage of the dependent library by a plurality of software including the given software, wherein the operation of obtaining the metadata comprises loading the metadata from the database to a cache memory based on evaluating the counter; and retrieving the metadata from the cache memory.

Clause 7. The computing system of any one of clauses 1-6, wherein the metadata further comprises a commit code snippet associated with the latest version of the dependent library, wherein the operations further comprise identifying a source code snippet in the given software that invokes the dependent library; and comparing similarity between the source code snippet and the commit code snippet.

Clause 8. The computing system of clause 7, wherein the operations further comprise converting the commit code snippet into a first embedded vector; and converting the source code snippet into a second embedded vector.

Clause 9. The computing system of clause 8, wherein the operations further comprise measuring a cosine similarity between the first embedded vector and the second embedded vector.

Clause 10. The computing system of any one of clauses 7-9, wherein the operation of generating the prompt comprises composing a text string including a change log associated with the latest version of the dependent library, the source code snippet, and one or more commit code snippets that are determined to be similar to the source code snippet; and replacing the placeholder with the text string.

Clause 11. A computer-implemented method comprising: identifying, based on an input received from a user interface, a current version of a dependent library used by a given software; obtaining, in runtime, metadata of the dependent library, wherein the metadata comprises one or more change logs of the dependent library, wherein the one or more change logs include descriptions of a latest version of the dependent library; generating, in runtime, a prompt based on a prompt template, wherein the prompt template includes a placeholder for receiving metadata of the dependent library; prompting, in runtime, a generative artificial intelligence (AI) model using the prompt to determine whether updating the dependent library from the current version to the latest version can cause a failure mode of the given software; and presenting a response generated by the generative AI model on the user interface.

Clause 12. The computer-implemented method of clause 11, wherein the dependent library is one of a plurality of dependent libraries used by the given software, wherein obtaining metadata, generating the prompt, prompting the generative AI model, and presenting the response are iteratively performed for the plurality of dependent libraries used by the given software.

Clause 13. The computer-implemented method of clause 12, further comprising retrieving the metadata of the dependent library from a source location; and storing the metadata of the dependent library in a database.

Clause 14. The computer-implemented method of clause 13, wherein the input specifies a project file of the given software, wherein identifying the dependent library comprises parsing the project file, wherein retrieving the metadata comprises generating a web address associated with the dependent library based on one or more fields obtained by the parsing; and tracing, from a website identified by the web address, to the source location.

Clause 15. The computer-implemented method of any one of clauses 13-14, further comprising maintaining a counter for total usage of the dependent library by a plurality of software including the given software, wherein obtaining the metadata comprises loading the metadata from the database to a cache memory based on evaluating the counter; and retrieving the metadata from the cache memory.

Clause 16. The computer-implemented method of any one of clauses 11-15, wherein the metadata further comprises a commit code snippet associated with the latest version of the dependent library, the method further comprising identifying a source code snippet in the given software that invokes the dependent library; and comparing similarity between the source code snippet and the commit code snippet.

Clause 17. The computer-implemented method of clause 16, further comprising converting the commit code snippet into a first embedded vector; and converting the source code snippet into a second embedded vector.

Clause 18. The computer-implemented method of clause 17, further comprising measuring a cosine similarity between the first embedded vector and the second embedded vector.

Clause 19. The computer-implemented method of any one of clauses 16-18, wherein generating the prompt comprises composing a text string including a change log associated with the latest version of the dependent library, the source code snippet, and one or more commit code snippets that are determined to be similar to the source code snippet; and replacing the placeholder with the text string

Clause 20. One or more non-transitory computer-readable media having encoded thereon computer-executable instructions causing one or more processors to perform a method, the method comprising: identifying, based on an input received from a user interface, a current version of a dependent library used by a given software; obtaining, in runtime, metadata of the dependent library, wherein the metadata comprises one or more change logs of the dependent library, wherein the one or more change logs include descriptions of a latest version of the dependent library; generating, in runtime, a prompt based on a prompt template, wherein the prompt template includes a placeholder for receiving metadata of the dependent library; prompting, in runtime, a generative artificial intelligence (AI) model using the prompt to determine whether updating the dependent library from the current version to the latest version can cause a failure mode of the given software; and presenting a response generated by the generative AI model on the user interface.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
memory;
one or more hardware processors coupled to the memory; and
one or more computer readable storage media storing instructions that, when loaded into the memory, cause the one or more hardware processors to perform operations comprising:
identifying, based on an input received from a user interface, a current version of a dependent library used by a given software;
obtaining, in runtime, metadata of the dependent library, wherein the metadata comprises one or more change logs of the dependent library, wherein the one or more change logs include descriptions of a latest version of the dependent library;
generating, in runtime, a prompt based on a prompt template, wherein the prompt template includes a placeholder for receiving metadata of the dependent library;
prompting, in runtime, a generative artificial intelligence (AI) model using the prompt to determine whether updating the dependent library from the current version to the latest version can cause a failure mode of the given software; and
presenting a response generated by the generative AI model on the user interface.

2. The computing system of claim 1, wherein the dependent library is one of a plurality of dependent libraries used by the given software, wherein the operations of obtaining metadata, generating the prompt, prompting the generative AI model, and presenting the response are iteratively performed for the plurality of dependent libraries used by the given software.

3. The computing system of claim 1, wherein the operations further comprise retrieving the metadata of the dependent library from a source location; and storing the metadata of the dependent library in a database.

4. The computing system of claim 3, wherein the operations of retrieving and storing the metadata are performed periodically based on a predefined schedule.

5. The computing system of claim 3, wherein the input specifies a project file of the given software, wherein the operation of identifying the dependent library comprises parsing the project file, wherein the operation of retrieving the metadata comprises generating a web address associated with the dependent library based on one or more fields obtained by the parsing; and tracing, from a website identified by the web address, to the source location.

6. The computing system of claim 3, wherein the operations further comprise maintaining a counter for total usage of the dependent library by a plurality of software including the given software, wherein the operation of obtaining the metadata comprises loading the metadata from the database to a cache memory based on evaluating the counter; and retrieving the metadata from the cache memory.

7. The computing system of claim 1, wherein the metadata further comprises a commit code snippet associated with the latest version of the dependent library, wherein the operations further comprise identifying a source code snippet in the given software that invokes the dependent library; and comparing similarity between the source code snippet and the commit code snippet.

8. The computing system of claim 7, wherein the operations further comprise converting the commit code snippet into a first embedded vector; and converting the source code snippet into a second embedded vector.

9. The computing system of claim 8, wherein the operations further comprise measuring a cosine similarity between the first embedded vector and the second embedded vector.

10. The computing system of claim 7, wherein the operation of generating the prompt comprises composing a text string including a change log associated with the latest version of the dependent library, the source code snippet, and one or more commit code snippets that are determined to be similar to the source code snippet; and replacing the placeholder with the text string.

11. A computer-implemented method comprising:
identifying, based on an input received from a user interface, a current version of a dependent library used by a given software;
obtaining, in runtime, metadata of the dependent library, wherein the metadata comprises one or more change logs of the dependent library, wherein the one or more change logs include descriptions of a latest version of the dependent library;
generating, in runtime, a prompt based on a prompt template, wherein the prompt template includes a placeholder for receiving metadata of the dependent library;
prompting, in runtime, a generative artificial intelligence (AI) model using the prompt to determine whether updating the dependent library from the current version to the latest version can cause a failure mode of the given software; and
presenting a response generated by the generative AI model on the user interface.

12. The computer-implemented method of claim 11, wherein the dependent library is one of a plurality of dependent libraries used by the given software, wherein obtaining metadata, generating the prompt, prompting the generative AI model, and presenting the response are iteratively performed for the plurality of dependent libraries used by the given software.

13. The computer-implemented method of claim 12, further comprising retrieving the metadata of the dependent library from a source location; and storing the metadata of the dependent library in a database.

14. The computer-implemented method of claim 13, wherein the input specifies a project file of the given software, wherein identifying the dependent library comprises parsing the project file, wherein retrieving the metadata comprises generating a web address associated with the dependent library based on one or more fields obtained by the parsing; and tracing, from a website identified by the web address, to the source location.

15. The computer-implemented method of claim 13, further comprising maintaining a counter for total usage of the dependent library by a plurality of software including the given software, wherein obtaining the metadata comprises loading the metadata from the database to a cache memory based on evaluating the counter; and retrieving the metadata from the cache memory.

16. The computer-implemented method of claim 11, wherein the metadata further comprises a commit code snippet associated with the latest version of the dependent library, the method further comprising identifying a source code snippet in the given software that invokes the dependent library; and comparing similarity between the source code snippet and the commit code snippet.

17. The computer-implemented method of claim 16, further comprising converting the commit code snippet into a first embedded vector; and converting the source code snippet into a second embedded vector.

18. The computer-implemented method of claim 17, further comprising measuring a cosine similarity between the first embedded vector and the second embedded vector.

19. The computer-implemented method of claim 16, wherein generating the prompt comprises composing a text string including a change log associated with the latest version of the dependent library, the source code snippet, and one or more commit code snippets that are determined to be similar to the source code snippet; and replacing the placeholder with the text string.

20. One or more non-transitory computer-readable media having encoded thereon computer-executable instructions causing one or more processors to perform a method, the method comprising:
identifying, based on an input received from a user interface, a current version of a dependent library used by a given software;
obtaining, in runtime, metadata of the dependent library, wherein the metadata comprises one or more change logs of the dependent library, wherein the one or more change logs include descriptions of a latest version of the dependent library;
generating, in runtime, a prompt based on a prompt template, wherein the prompt template includes a placeholder for receiving metadata of the dependent library;
prompting, in runtime, a generative artificial intelligence (AI) model using the prompt to determine whether updating the dependent library from the current version to the latest version can cause a failure mode of the given software; and
presenting a response generated by the generative AI model on the user interface.
